(19) United States
(12) Patent Application Publication
(10) Pub. No.: US 2009/0240502 A1
(43) Pub. Date: Sep. 24, 2009

(54) MULTIMEDIA CONTROLLER TABLET

(75) Inventor: Richard KEMPLIN, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignees: Sony Corporation, Tokyo (JP); Sony Electronics Inc., Parkridge, NJ (US)

(21) Appl. No.: 12/053,764

(22) Filed: Mar. 24, 2008

(51) Int. Cl. G10L 21/06; G05B 19/02

(52) U.S. Cl. 704/275; 340/825.22

(57) ABSTRACT

A media controller tablet is disclosed comprising: an ergonomic housing including a pair of complimentary curvilinear surfaces tapering from an upper end to a lower end, and a gripping surface in contact with one of the complimentary curvilinear surfaces wherein the gripping surface and the complimentary curvilinear surfaces are adapted to engage a human hand with a palm of the human hand in contact with one of the pair of complimentary curvilinear surfaces and a plurality of fingers of the human hand wrapped around the gripping surface; a controller embedded in the ergonomic housing and adapted to receive an input and wirelessly control a media device in accordance with the input; and a display integrated with the ergonomic housing and connected with the controller for displaying information about media content available for viewing on the media device.

### BACKGROUND OF THE INVENTION

1. Field of the Invention

The present invention relates generally to wireless tablets. More specifically the present invention relates to wireless tablets for controlling multimedia appliances.

2. Discussion of the Related Art

Multimedia appliances have proliferated along with wireless remote control devices for controlling the appliances. These wireless remote control devices tend to be appliance specific. It is not uncommon for a homeowner to have multiple media appliances each having a separate and unique remote control for controlling the appliance. For example, the homeowner may have a television controller, a cable box controller, a stereo system controller and a Digital Video Disc (DVD) controller for controlling an integrated stereo and television system setup. This federated approach to controlling the individual devices that comprise a single multimedia experience is often confusing and frustrating.

Several attempts have been made to create a universal controller for controlling all the devices that comprise the multimedia experience. These universal controllers are usually large and confusing to use. They feature many small buttons, frequently fifty or more, with some of the buttons being appliance unique and some of the buttons common to two or more appliances. For example, a screen navigation control button might be applicable only for controlling a television display menu driven by the cable box while a fast forward button might be used for controlling an on demand movie playing through the set top box, a movie playing through the DVD and an audio track playing through the stereo system.

Tablet computing devices have also proliferated in recent years. Tablets have become smaller and easier to use and in many cases have processors and memory that provide computational power and data storage sizes similar to that of a Personal Computer (PC). As a result, many tablets have similar capabilities to a desktop PC such as a processor driven display, a wireless networking feature and a USB data transfer capability. Moreover, the tablets can be packaged inexpensively as relatively small devices.

Those skilled in the art will recognize that there is a need for a small and easy to use multimedia controller having many of the features available in a desktop PC. The present invention addresses this need as well as others needs.

### SUMMARY OF THE INVENTION

In one embodiment, the invention can be characterized as a media controller tablet, comprising: an ergonomic housing including a pair of complimentary curvilinear surfaces tapering from an upper end to a lower end, and a gripping surface in contact with one of the complimentary curvilinear surfaces wherein the gripping surface and the complimentary curvilinear surfaces are adapted to engage a human hand with a palm of the human hand in contact with one of the pair of complimentary curvilinear surfaces and a plurality of fingers of the human hand wrapped around the gripping surface; a controller embedded in the ergonomic housing and adapted to receive an input and wirelessly control a media device in accordance with the input; and a display integrated with the ergonomic housing and connected with the controller for displaying information about media content available for viewing on the media device.

In another embodiment, the invention can be characterized as a handheld media device controller, comprising: a housing adapted to be cradled in a hand; a controller located substantially within the housing for controlling a media device; and a display coupled to the housing for displaying content that corresponds to media content available through the media device.

In a further embodiment, the invention may be characterized as a remote control device for controlling a plurality of media devices, the remote control device having: a housing adapted to be held in a hand; a controller inside the housing adapted to receive content information from each of the plurality of media devices; and a display coupled to the housing for displaying the content information from each of the plurality of media devices.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an illustration of a multimedia controller tablet in communication with exemplary multimedia devices according to an embodiment of the invention.

FIG. 2 is an illustration of a multimedia controller tablet showing a guide page according to an embodiment of the invention.

FIG. 3 is an illustration of a multimedia controller tablet showing a DVD page according to an embodiment of the invention.

FIG. 4 is an illustration of a multimedia controller tablet showing a TV page according to an embodiment of the invention.

FIG. 5 is an illustration of a multimedia controller tablet showing an audio page according to an embodiment of the invention.

FIG. 6 is a functional block diagram of a multimedia controller tablet according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment”, “an embodiment”, or similar language means that a particular feature, structure, or characteristic described in connection with the embodiment is included in at least one embodiment of the present invention. Thus, the appearance of the phrase “in one embodiment”, “in an embodiment”, or similar language throughout the specification may, but does not necessarily, refer to the same embodiment.

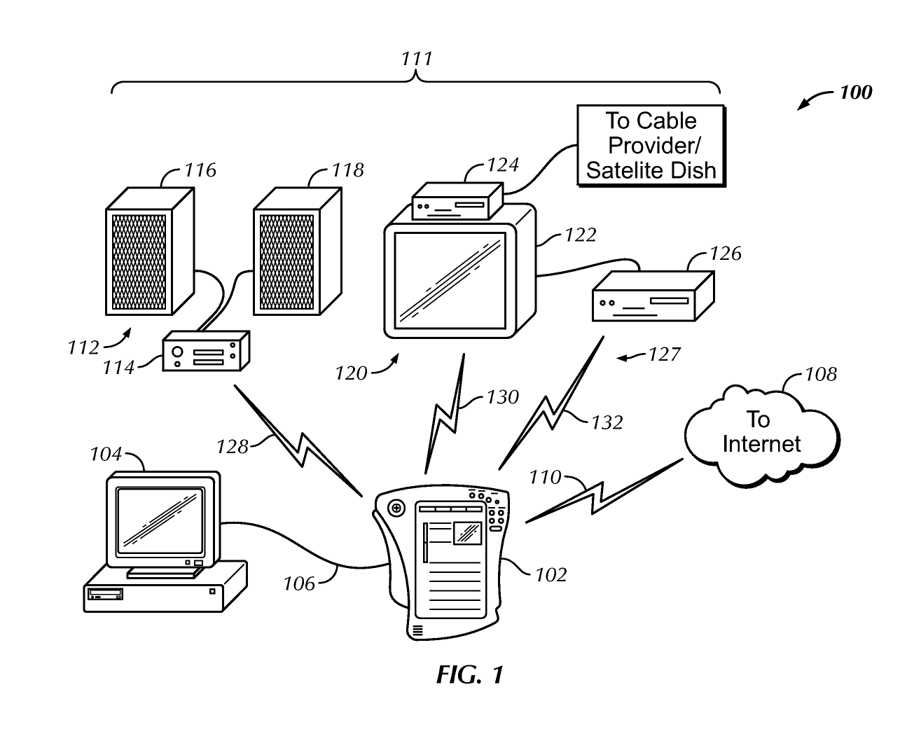

Referring first to FIG. 1, an exemplary multimedia environment 100 and a multimedia controller tablet 102 are shown according to an embodiment of the invention. The multimedia controller tablet 102 is in communication with a PC 104 through a cable 106 and in communication with the internet 108 through a wireless internet access network 110. The multimedia controller tablet 102 is also in communication with a plurality of multimedia devices 111 that comprise; a stereo system 112 that includes a receiver 114, a left speaker 116 and a right speaker 118; and a television system 120 that includes a television 122, a cable box 124 and a DVD player 126. The multimedia controller controls the multimedia devices 111 through a plurality of wireless data links 127, specifically wireless data links 128, 130, 132.

The multimedia tablet controller 102, explained further hereinafter, is operable to exchange data with the PC 104 through the cable 106. Cable 106 in several embodiments is a USB cable with the multimedia table controller and PC 104 having USB compliant USB jack or port. Other embodiments feature other types of cables and other types of wired line protocols. Still other embodiments feature a wireless connection between the multimedia controller 102 and the PC 104. The wireless protocol for the wireless connection may be any wireless protocol that facilitates an appropriate data exchange. An appropriate wireless protocol might for example be the Bluetooth networking protocol.

In this embodiment, the multimedia controller tablet 102 is operable to download television programming guides as well as video and music files (i.e. video tracks and audio tracks) from the personal computer 102. It can be appreciated that the multimedia controller tablet 102 has a processor and memory and can store and execute a variety of computational algorithms and data structures. The multimedia controller tablet 102 is also operable to download application software and software updates for the multimedia controller tablet 102. Application software might, for example, include software modules for controlling one or more of the plurality of multimedia devices 111 and software modules for generating appropriate multimedia controller tablet 102 user interfaces. One example of application software might be software modules that generate the user interface and wireless commands for controlling the Sony Bravia television set.

The multimedia controller table 102 is also operable to connect to the internet 108 through a wireless internet access network 110. The wireless internet access network 110 might be for example a WiFi network. The wireless internet access network 110 might also be for example a virtual network created by establishing a local area network with an internet access gateway, such as PC 104, that in turn may be connected to the internet through a DSL line, cable modem or other communication device.

The multimedia controller 102 is also in communication with the plurality of multimedia devices 111 through the plurality of wireless data links 127. In this embodiment, the plurality of wireless data links 127 are two way data links established according to the Bluetooth protocol. In other embodiments, the data links are one way data links from the multimedia controller 102 to the plurality of multimedia devices 111. In several embodiments, the plurality of wireless data links 127 are radio frequency data links or infrared data links.

In this embodiment, the multimedia tablet controller 102 is operable to receive information from the plurality of multimedia devices 111. For example, the multimedia controller may receive program guide data from the cable box 124 or information about the DVD content available on a DVD from the DVD player 126. In other embodiments, the multimedia tablet controller receives guide data and other multimedia information from the PC 104 or the internet 108. The transfer of data from a stereo receiver 114, television set 120 or any other communication capable device is also contemplated. Synch operations to synch information stored in the multimedia tablet controller 102 and the plurality of multimedia devices 111, the PC 104 or any other networked device is also contemplated.

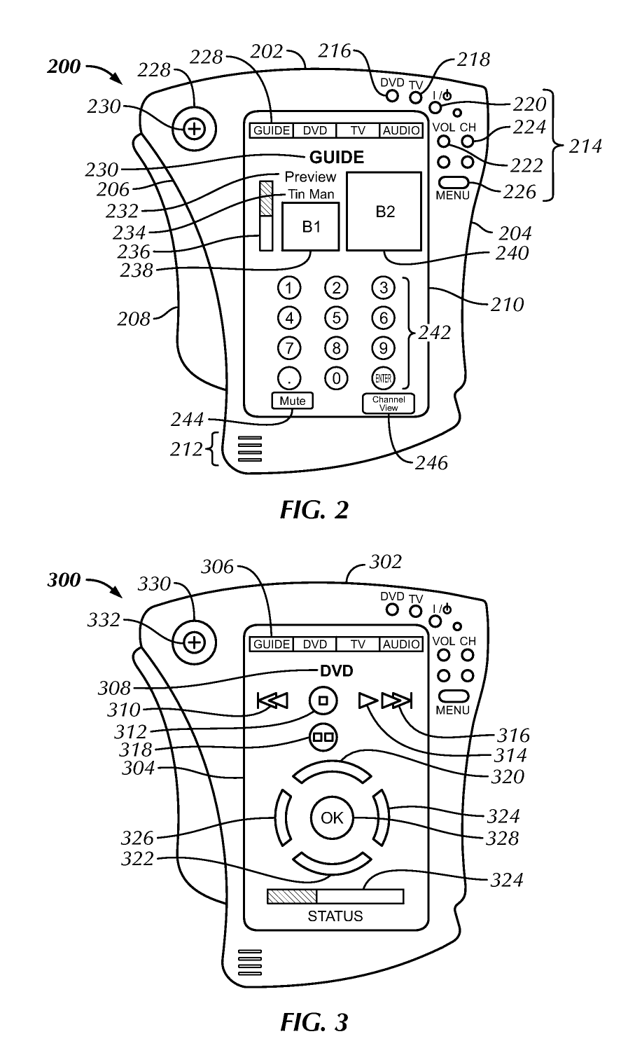

Referring next to FIG. 2, a multimedia tablet controller 200 according to an embodiment of the invention is shown. The multimedia tablet controller 200 is packaged in an ergonomic housing 202 that includes a pair of complimentary curvilinear surfaces 204, 206. The first curvilinear surface 204 is curved to engage the palm of a hand. The second curvilinear surface 206 is in contact with a gripping surface 208. The ergonomic housing 202 has a display 210 integrated with the ergonomic housing 202 and a controller (not shown) embedded inside the ergonomic housing 202. The ergonomic housing 202 also has a microphone 212 and USB port (not shown).

The pair of complimentary curvilinear surfaces 204, 206 cooperates with the gripping surface 208 to provide a user of the multimedia tablet controller 200 with ergonomic surfaces for cradling the device in the hand, and operating the device with either the cradling hand or another hand. Preferably, the gripping surface 208 is substantially composed of an elastic material with the gripping surface 208 deforming to accommodate the grip of the cradling hand.

The multimedia tablet controller 200 has a plurality of buttons 214 located in the upper right portion of the ergonomic housing 202. The plurality of buttons in this embodiment includes a DVD button 216, a TV button 218, an on/off button 220, a volume pair 222 a channel pair 224, and a menu button 226. On the left side of the ergonomic housing 202 a track ball 228 and select button 230 are provided.

The plurality of buttons 214 in this embodiment, are configured on the right upper portion of the ergonomic housing 202, a position that allows the buttons to be easily selected using the right thumb of the cradling hand. The buttons 214 provide the user with some of the most basic control functions available. The DVD button 216 focuses control of the plurality of buttons 214 for operations on the DVD. The TV button 218 focuses control of the plurality of buttons 214 for operations on the television. The on/off button turns the TV, DVD or other selected device on and off. The volume pair 222 raises and lowers the volume of a selected device and the channel pair 224 raises or decrements the channel of a selected device. A menu button 226 allows the user to command the display of a menu screen on the selected device or on the display 210.

In this embodiment, the display 210 is a touch screen display and the user may make selections via touch input to the screen. In other embodiments the track ball 228 and the select button 230 are used for user input. The use of a stylus pen, keyboard and other input mechanisms is also contemplated.

The display 210 has a select bar 228 located at the top of the display. In this embodiment, the select bar 228 allows the user to choose a guide page, a DVD page, a TV page or an audio page. Below the select bar 228 is a current page line 230 that indicates the page that is currently selected. In this case, the current page line 230 indicates that the guide page is currently selected. In alternate embodiments, the guide portion of the select bar 228 may be highlighted, bolded, enlarged or otherwise emphasized to indicate that the guide page is currently selected.

Below the current page line 230 is a mode line 232 that shows the current display mode. In this case, the display mode is preview mode. A title line 234 is provided underneath the mode line 232 that indicates the title of a movie being previewed. In this case the title is “Tin Man”. An elapsed time indicator 236 is also provided showing the amount of time remaining in the “Tin Man” preview. A summary area 238 is also provided with a text preview of the movie. The summary area might be populated with a text summary for the Tin Man. The text summary might for example read:

A young girl and three strange companions embark on a quest in a magical realm in this miseries update of the classic L Frank Baum tale. MPGA Rating: None User Rating: Five stars. Your Rating: Two stars.

Provided next to the text summary in the summary area 238 is a video preview area 240 for showing a preview, trailer, or the like of a movie. In this case, a trailer for the movie “Tin Man” might be showing. An audio track from the Tin Man may also be played through a speaker 212 embedded in the housing 202. Below the summary area 238 and the video preview 240 is a numeric keypad 242 that allows the user to select a different channel for preview. Below the numeric keypad 242 a mute button 244 is provided to mute the audio track. Next to the mute button 244 is a channel view button 246 for viewing an alternate user interface that may show for example a menu with all the channels available.

Those skilled in the art will readily recognize that the display area can be used to display a variety of graphical user interfaces (GUIs). For example, a GUI can be provided for viewing a page having a picture in picture of a current playing movie, for displaying a page having a television programming schedule, a page having a movie schedule, a page having a satellite radio schedule, a page having on-demand list, a page having an electronic programming guide, or any other multimedia related page. The GUIs may also be directed to accessing content available only on the multimedia controller tablet 200 such as downloaded audio tracks, games or other executable programs or data.

Referring next to FIG. 3, a multimedia tablet controller 300 showing a DVD page according to an embodiment of the invention is shown. The multimedia tablet has a housing 302 with a display 304 integrated in the housing 302. The display 304 shows the DVD page. The DVD page includes a select bar 306 located at the top of the display. In this embodiment, the select bar 306 allows the user to choose a guide page, a DVD page, a TV page or an audio page. Below the select bar 306 is a current page line 308 that indicates the type of page that is currently selected. In this case, the current page line 308 indicates that the DVD page is currently selected. In alternate embodiments, the guide portion of the select bar 306 may be highlighted or emphasized to indicate that the DVD page is currently selected.

Just above the current page line 308 is a rewind select key 310 for commanding the DVD player to go backward in play time. Next to the rewind select key 310 is a stop key 312 for commanding the DVD player to stop playing. Next to the stop key 312 is a fast forward key 314 for commanding the DVD player to jump forward in play time. Underneath the stop button 312 is a pause button 318 for pausing the DVD player.

Below the pause button 318 is a series of keys for navigating DVD menu pages. There is an up button 320 a down button 322, a right button 324 and a left button 326 as well as a select button 328. A DVD play status bar 324 underneath the series of keys is also provided.

It can be appreciated that the basic DVD command buttons 310, 312, 314, 316, 318 are configured in a simple and easy to understand configuration. The configuration is consistent with the configuration of the control keys on many conventional remote control devices making the use of command buttons 310, 312, 314, 316, 318 intuitive to new users of the multimedia controller tablet 300. The button motif is also consistent with many stereo systems and the layout motif can be applied to other GUI's for controlling these devices as well. The series of keys for navigating the DVD menus 320, 322, 324, 326 are also provided in a simple and easy to understand configuration consistent with many conventional remote control devices. Advantageously, the command buttons 310, 312, 314, 316, 318 and DVD menus 320, 322, 324, 326 configuration is not fixed and as the user selects different pages only the buttons applicable to the need be displayed. The status bar 326 at the bottom provides a quick and intuitive indication of how much of the DVD content has been viewed.

In this embodiment, the display 304 is a touch screen display and selection of the buttons can be accomplished by touching the corresponding area of the display. In other embodiments a track ball 330 and a select key 332 can be used to select the buttons. In still other embodiments, the track ball 330 and select key 332 may be used to navigate the DVD screen.

One skilled in the art will recognize that the DVD page as well as other multimedia control GUI's can be embodied in a variety of formats. The DVD page may be tailored for use with a particular DVD player according to the preferences of a particular user or any other criteria. The versatility of a touch screen display allows for easy navigation and intuitive GUIs for navigating pages and controlling multimedia devices.

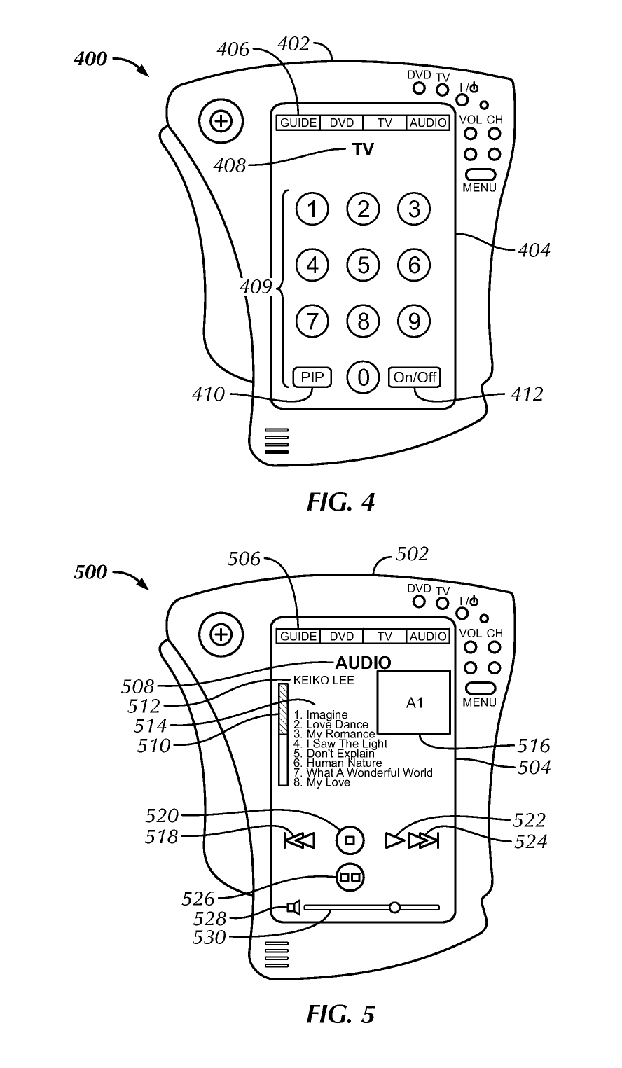

Referring next to FIG. 4, a multimedia tablet controller 400 showing a TV page according to an embodiment of the invention is shown. The multimedia controller tablet has a housing 402 with a display 404 integrated in the housing 402. The display 404 shows the TV page. The TV page includes a select bar 406 located at the top of the display. In this embodiment, the select bar 406 allows the user to choose a guide page, a DVD page, a TV page or an audio page. Below the select bar 406 is a current page line 408 that indicates the TV page that is currently selected and being displayed. In alternate embodiments, the guide portion of the select bar 406 may be highlighted or emphasized to indicate that the TV page is currently selected.

Below the current page line 408 a numeric keypad 409 is shown with a pip 410 button and an on/off button 412. The numeric keypad 409 can be used for selecting television channels. The picture in picture button 410 allows the user to command a picture in picture display on the television set. The on/off button allows a user to easily turn the television set on or off.

Referring next to FIG. 5, a multimedia tablet controller 500 showing an audio page according to an embodiment of the invention is shown. The multimedia tablet has a housing 502 with a display 504 integrated in the housing 502. The display 504 shows the audio page. The audio page includes a select bar 506 located at the top of the display. In this embodiment, the select bar 506 allows the user to choose a guide page, a DVD page, a TV page or an audio page. Below the select bar 506 is a current page line 508 that indicates the audio page that is currently selected and being displayed. In alternate embodiments, the audio portion of the select bar 506, may be highlighted or emphasized to indicate that the audio page is currently selected and being displayed.

Below the current page line 508 is a status indicator 510 that indicates the status of the current track being played. An artist line 512 shows the artist as Keiko Lee and a track listing 514 lists the tracks available. In this case, track 1 is “Imagine”, track 2 is “Love Dance”, track 3 is “My Romance”, track 4 is “I Saw the Light”, track 5 is “Don't Explain”, track 6 is “Human Nature”, track 7 is “What a Wonderful World and track 8 is “My Love”. A display 516 next to the artist line 512 and the track listing 514 provides a video area 516 for playing a related video, displaying album art or the like. On the lower half of the display area is a rewind select key 518 for commanding the audio player to go backward in play time. Next to the rewind select key 518 is a stop key 520 for commanding the audio player to stop playing. Next to the stop key 520 is a play key 522 for commanding the audio player to play and a fast forward key 524 for commanding the audio player to jump forward in play time. Underneath the stop button 520 is a pause button 526 for pausing the audio player.

Underneath the pause button 526 a volume button 528 is provided as well as a slider 530. The volume button 526 allows a user to adjust the output volume and the slider 530 allows for advancing or reversing in time the play of the audio track. Advantageously these buttons have a look and feel similar to an audio track player on a PC.

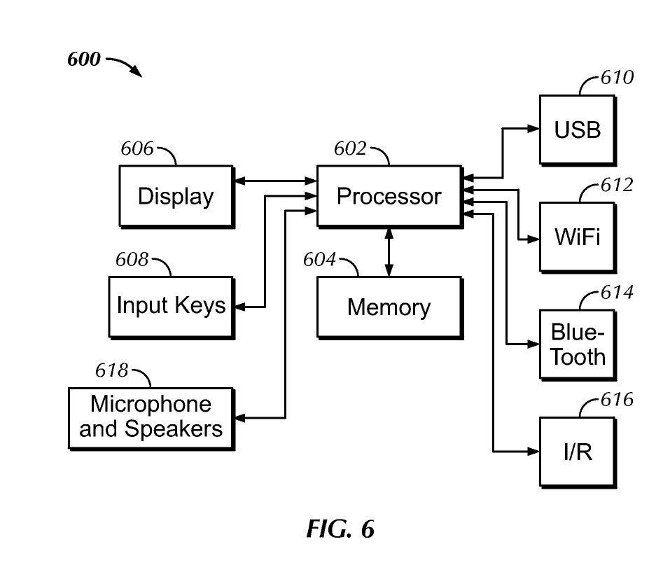

Referring next to FIG. 6, a functional block diagram 600 of a multimedia controller tablet according to an embodiment of the invention is shown. The multimedia controller has a processor 602 functionally linked to a memory 604, a display 606, input keys 608, a USB interface 610, a WiFi interface 612, a Bluetooth interface 614, and an infrared (I/R) port 616.

The processor 602 communicates with the memory 604 and they cooperate to save multimedia controller tablet programs and data. The programs include control modules for controlling multimedia devices as well as modules for controlling the internal functions of the multimedia controller tablet. The memory 604 may also store video, audio tracks, user preferences, programs, applications, display drivers, networking protocols, calculation engines, and the like. The processor 602 also drives the display 606. The display 606 is preferably a touch screen display that allows the user to make control inputs and selections to the multimedia controller tablet. The processor 602 is also connected with the input keys 608 for receiving track ball inputs, select key inputs, button inputs, key inputs and the like entered by a user.

The processor 602 also communicates with the USB interface 610 to facilitate wired data exchange between the multimedia controller tablet and an external device such as a PC. The processor 602 also communicates with a WiFi interface 612 for wireless data exchange between the multimedia controller tablet and internet enabled devices. The processor communicates with a Bluetooth interface 614 for wireless data exchange with multimedia devices and other devices in the proximate area. The processor 616 also communicates with the IR port for sending infrared commands to multimedia devices in the immediate area.

It can be appreciated that the USB interface 610, the WiFi interface 612 and the Bluetooth interface 614 may provide a high bandwidth two way data bridge between the processor 602 and a multimedia device, computer or other storage device. The multimedia device computer or other storage device in turn may have a database or a virtual connection with a database. Data stored in the multimedia device or accessible by the multimedia device, such as electronic programming guides, digital music, movie trailers or other information may be virtually accessed, executed or stored for later use by the multimedia controller tablet through the WiFi interface 612 or the Bluetooth interface 614. Similarly, programs and data stored or executed on the multimedia controller tablet such as user preferences, user selections, voice recordings, digital music, and video trailers may be shared with other multimedia devices. The use of the multimedia device as a data conduit between multimedia devices, computers and other devices is also contemplated.

It can be appreciated that the multimedia tablet controller may have two way or one way communication links with a multimedia device. For example, in a preferred embodiment the USB interface 610, the WiFi interface 612 and the Bluetooth interface 614 support bidirectional communication, while the I/R port 616 supports one way communication.

Processor 602 is also functionally connected with a microphone and speakers 618. The microphone and speakers 618 providing an audio input and output for the multimedia controller tablet. Audio input could be stored as a recording in memory 604 or could be processed by the processor 602 to extract a voice command. The voice command could in turn be used to control one of the multimedia devices.

Those skilled in the art will recognize there are many structural and functional embodiments of the multimedia controller tablet. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

While the invention herein disclosed has been described by means of specific embodiments, examples and applications thereof, numerous modifications and variations could be made thereto by those skilled in the art without departing from the scope of the invention set forth in the claims.

What is claimed is:

1. A media controller tablet, comprising:
an ergonomic housing including a pair of complimentary curvilinear surfaces tapering from an upper end to a lower end, and a gripping surface in contact with one of the complimentary curvilinear surfaces wherein the gripping surface and the complimentary curvilinear surfaces are adapted to engage a human hand with a palm of the human hand in contact with one of the pair of complimentary curvilinear surfaces and a plurality of fingers of the human hand wrapped around the gripping surface;
a controller embedded in the ergonomic housing and adapted to receive an input and wirelessly control a media device in accordance with the input; and
a display integrated with the ergonomic housing and connected with the controller for displaying information about media content available for viewing on the media device.

2. The media controller tablet of claim 1 further comprising a microphone coupled to the controller for receiving an audio input.

3. The media controller tablet of claim 2 wherein the controller is adapted to recognize a voice command received through the microphone.

4. The media controller tablet of claim 1 further comprising an audio port coupled to the controller and adapted to output an audio signal corresponding to an audio track.

5. The media controller tablet of claim 1 wherein the gripping surface of the ergonomic housing is substantially composed of an elastic material.

6. The media controller tablet of claim 1 wherein the gripping surface is adapted to engage four fingers of the human hand.

7. The media controller tablet of claim 1 further comprising a USB port connected to the controller, the USB port and the controller adapted to transfer media content between a USB device and the controller.

8. The media controller tablet of claim 1 wherein the controller is WiFi enabled and operable to receive media content from the internet.

9. The media controller tablet of claim 1 wherein the controller is Bluetooth enabled and the media device is Bluetooth enabled, and the controller is operable to receive media content from the media device through a Bluetooth link.

10. The media controller tablet of claim 1 wherein the display is a touch screen display and the touch screen display is adapted to receive the input for controlling the media device.

11. The media controller tablet of claim 1 wherein the controller is operable to display a guide on the display.

12. A handheld media device controller, comprising:
a housing adapted to be cradled in a hand;
a controller located substantially within the housing for controlling a media device; and
a display coupled to the housing for displaying content that corresponds to media content available through the media device.

13. The handheld media device controller of claim 12 wherein the housing has a plurality of curvilinear surfaces and a plurality of buttons arranged in an ergonomic configuration for actuation by the hand.

14. The handheld media device controller of claim 12 wherein the housing has a plurality of curvilinear surfaces and the display is a touch screen display.

15. The handheld media device controller of claim 12 further comprising a wireless component connected with the controller, the wireless means adapted to communicate over a network.

16. The handheld media device controller of claim 12 wherein the media device is a television.

17. The handheld media device controller of claim 12 wherein the media device is a digital video disc player.

18. The handheld media device controller of claim 12 wherein the media device is stereo system.

19. A remote control device for controlling a plurality of media devices, the remote control device having:
a housing adapted to be held in a hand;
a controller inside the housing adapted to receive content information from each of the plurality of media devices; and
a display coupled to the housing for displaying the content information from each of the plurality of media devices.

20. The remote control of claim 19 wherein the content information from each of the plurality of media devices includes a listing of available media content.
